(19) United States
(12) Patent Application Publication
(10) Pub. No.: US 2023/0039738 A1
(43) Pub. Date: Feb. 9, 2023

(54) METHOD AND APPARATUS FOR ASSESSING TRAFFIC IMPACT CAUSED BY INDIVIDUAL DRIVING BEHAVIORS

(71) Applicant: HERE Global B.V., Eindhoven (NL)

(72) Inventors: Jerome BEAUREPAIRE, Berlin (DE); Leon STENNETH, Chicago, IL (US); Jeremy Michael YOUNG, Chicago, IL (US)

(21) Appl. No.: 17/387,687

(22) Filed: Jul. 28, 2021

(51) Int. Cl. G08G 1/01

(52) U.S. Cl. CPC G08G 1/0112; G08G 1/0133; G08G 1/0137

(57) ABSTRACT

An approach is provided for accessing traffic impact caused by individual driving behaviors. For example, the approach involves receiving, by one or more processors, sensor data collected from one or more sensors of a vehicle traveling on a road network. The approach also involves processing, by the processors, the sensor data to determine one or more driving behaviors associated with the vehicle. The approach further involves computing, by the processors, a traffic impact index based on the one or more driving behaviors and at least one contextual parameter associated with the vehicle, the road network, a driver of the vehicle, or a combination thereof. The traffic impact index represents an estimated impact of the vehicle on a traffic flow within at least a portion of the road network. The approach further involves providing, by the processors, the traffic impact index as an output.

### BACKGROUND

There are macroscopic traffic flow models that simulate traffic flows based on density, flow, mean speed of a traffic stream, etc. by integrating microscopic traffic flow models. Some research focuses on simulating distracted drivers' effects (e.g., caused by non-driving activities, such as texting, calling, drinking, eating, chatting, etc.) on traffic flows. However, the actual impacts of individual's driving maneuvers and actions (e.g., frequently changing lanes, unnecessary braking, driving way below speed limits, etc.) on the traffic flow remains under-explored. For instance, usage-based insurance (UBI) collects vehicle sensor data only to adjust insurance premium based on time, distance, behavior, place, etc. Accordingly, service providers face significant technical challenges to access traffic flow impact caused by individual's driving behaviors.

### SOME EXAMPLE EMBODIMENTS

Therefore, there is need for an approach for accessing traffic impact caused by individual driving behaviors, such as frequently changing lanes, unnecessary braking, etc., thereby recommending the individual to change or proceed with the driving behaviors, taking a route, etc. either to avoid the traffic impact if undesirable or to encourage the traffic impact if desirable.

According to example embodiment(s), a computer-implemented method comprises receiving, by one or more processors, sensor data collected from one or more sensors of a vehicle traveling on a road network. The method also comprises processing the sensor data to determine one or more driving behaviors associated with the vehicle. The method further comprises computing a traffic impact index based on the one or more driving behaviors and at least one contextual parameter associated with the vehicle, the road network, a driver of the vehicle, or a combination thereof. The traffic impact index represents an estimated impact of the vehicle on a traffic flow within at least a portion of the road network. The method further comprises providing, by the one or more processors, the traffic impact index as an output.

According to another embodiment, an apparatus comprises at least one processor, and at least one memory including computer program code for one or more programs, the at least one memory and the computer program code configured to, with the at least one processor, to cause, at least in part, the apparatus to receive sensor data collected from one or more sensors of a vehicle traveling on a road network. The apparatus is also caused to process the sensor data to determine one or more driving behaviors associated with the vehicle. The apparatus is further caused to compute a traffic impact index based on the one or more driving behaviors and at least one contextual parameter associated with the vehicle, the road network, a driver of the vehicle, or a combination thereof. The traffic impact index represents an estimated impact of the vehicle on a traffic flow within at least a portion of the road network. The apparatus is further caused to provide the traffic impact index as an output.

According to another embodiment, a computer-readable storage medium carrying one or more sequences of one or more instructions which, when executed by one or more processors, cause, at least in part, an apparatus to receive sensor data collected from one or more sensors of a vehicle traveling on a road network. The apparatus is also caused to process the sensor data to determine one or more driving behaviors associated with the vehicle. The apparatus is further caused to compute a traffic impact index based on the one or more driving behaviors and at least one contextual parameter associated with the vehicle, the road network, a driver of the vehicle, or a combination thereof. The traffic impact index represents an estimated impact of the vehicle on a traffic flow within at least a portion of the road network. The apparatus is further caused to provide the traffic impact index as an output.

According to another embodiment, an apparatus comprises means for receiving sensor data collected from one or more sensors of a vehicle traveling on a road network. The apparatus also comprises means for processing the sensor data to determine one or more driving behaviors associated with the vehicle. The apparatus further comprises means for computing a traffic impact index based on the one or more driving behaviors and at least one contextual parameter associated with the vehicle, the road network, a driver of the vehicle, or a combination thereof. The traffic impact index represents an estimated impact of the vehicle on a traffic flow within at least a portion of the road network. The apparatus further comprises means for providing the traffic impact index as an output.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of accessing traffic impact caused by individual driving behaviors, according to example embodiment(s);

FIG. 2A is a diagram illustrating example concerning driving behaviors, according to example embodiment(s);

FIG. 2B is a diagram of an example machine learning data matrix, according to example embodiment(s);

FIG. 3 is a diagram of the components of a driving platform capable of accessing traffic impact caused by individual driving behaviors, according to example embodiment(s);

FIG. 4 is a flowchart of a process for accessing traffic impact caused by individual driving behaviors, according to example embodiment(s);

FIGS. 5A-5E are diagrams of example map user interfaces associated with accessing traffic impact caused by individual driving behaviors, according to example embodiment(s);

FIG. 6 is a diagram of a geographic database, according to example embodiment(s);

FIG. 7 is a diagram of hardware that can be used to implement an embodiment of the invention, according to example embodiment(s);

FIG. 8 is a diagram of a chip set that can be used to implement an embodiment of the invention, according to example embodiment(s); and

FIG. 9 is a diagram of a mobile terminal (e.g., handset or vehicle or part thereof) that can be used to implement an embodiment.

### DESCRIPTION OF SOME EMBODIMENTS

Examples of a method, apparatus, and computer program for accessing traffic impact caused by individual driving behaviors are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

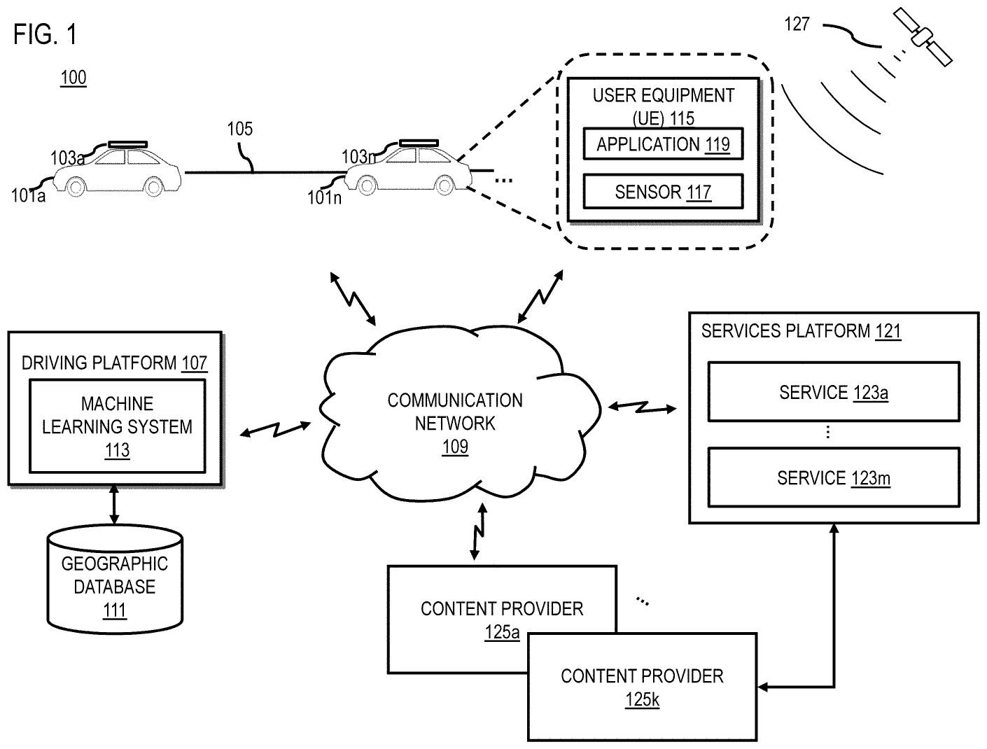

FIG. 1 is a diagram of a system capable of accessing traffic impact caused by individual driving behaviors, according to example embodiment(s). Service providers and vehicle manufacturers are increasingly developing compelling navigation and other location-based services that improve the overall driving experience and safety by leveraging vehicle capabilities, such as autonomous driving, reporting road events using sensor data collected by connected vehicles as they travel, etc. For example, the vehicles can use their respective sensors to detect road conditions, surrounding vehicles, etc., which in turn can be used for issuing local hazard warning, updating real-time mapping data, as inputs to a mapping database. Some usage-based auto insurance (UBI) plans calculate/rate user's driving efficiency via monitoring the miles driven, accelerations/decelerations, etc., in order to charge premiums based on how safe an individual drives, for example, based on driving habits, driving's behaviors (e.g., speeding, heavy braking, sudden lane changing, etc.). There are systems provide diving behavior suggestions for individual gains, such as reducing travel time, promoting smooth driving experience, increasing fuel efficiency, etc., but not to improve the traffic flow.

Traffic congestion can be contributed to individual driving behaviors, such as speeding, changing lanes frequently, etc. By way of example, even if only one driver brakes unnecessarily on a busy road can trigger a chain of disturbances/events of other drivers' reactions and adjustments that slow down the traffic. Sometimes such concerning individual driving behaviors are intentional (e.g., frequently changing lanes, tailgating driving, etc.). On the other hand, such concerning individual driving behaviors can be bad habits, such as unnecessary or excessive braking, that the individual is unaware of their existence and/or traffic impacts. As mentioned, there is no solution on assessing the actual impacts of individual's driving maneuvers and actions (e.g., frequently changing lanes, unnecessary braking, driving way below speed limits, etc.) on the traffic flow.

To address these problems, the system 100 of FIG. 1 introduces a capability to access traffic impact caused by individual driving behaviors. In one embodiment, the system 100 can receive sensor data collected by sensors (e.g., cameras, motion sensors, Light Detection and Ranging (LiDAR), etc.) installed in a vehicle to record driving behavior data of an individual as well as the impact on ethe traffic flow caused by the driving behaviors in real environment. The system 100 can quantify the traffic impact of a user's behavior on traffic flow, i.e., the traffic flow difference with or without concerning driving behavior(s). Of course, every vehicle has an impact by default by simply being on the road; however this impact can go from good, neutral, to bad or even worst. For instance, neutral can be when the vehicle is alone on the highway, not disturbing any objects (e.g., other vehicles, pedestrians, etc.). The system 100 can then assess this impact by constantly monitoring the vehicle environment and evaluating the possibly traffic impact it has consider different contextual parameters. For instance, when changing lanes in a non-optimal way on the highway, the impact on the overall traffic is minimal. In city centers, however, one driver's behavior can much more impact on the traffic. For instance, blocking a lane when parking improperly can cause serious traffic congestion.

As shown FIG. 1, the system 100 comprises one or more vehicles 101a-101n (also collectively referred to as vehicles 101) respectively equipped with sensors 103a-103n (also collectively referred to as sensors 103) for sensing individual driving behaviors, and/or their traffic impact on one or more road segments 105 of a transportation network (e.g., a road network). For instance, the system 100 can determine one or more concerning driving behaviors (e.g., frequently changing lanes, unnecessary braking, driving seriously under the speed limit, etc.) occurring on the road segment(s) 105 based on the sensor data associated with a vehicle 101 and one or more contextual parameters (e.g., current vehicle model/size/speed/etc., neighboring vehicle models/sizes/speeds/etc., existing traffic, road surface conditions, weather, road work, events, etc.).

The impact of the concerning driving behaviors (mostly negative, but sometimes positive) on traffic flow (e.g., traffic density, flow, means speed of a traffic stream, etc.) can be estimated based on the sensor data as well. When the number of negative driving behaviors (e.g., frequent lane changing) increases, the average headway and speed of the traffic flow decrease, and the speed dispersion increases. On the other hand, when the number of positive driving behaviors (e.g., overtaking a car driving seriously under the speed limit) increases, the average headway and speed of the traffic flow increase, and the speed dispersion decreases.

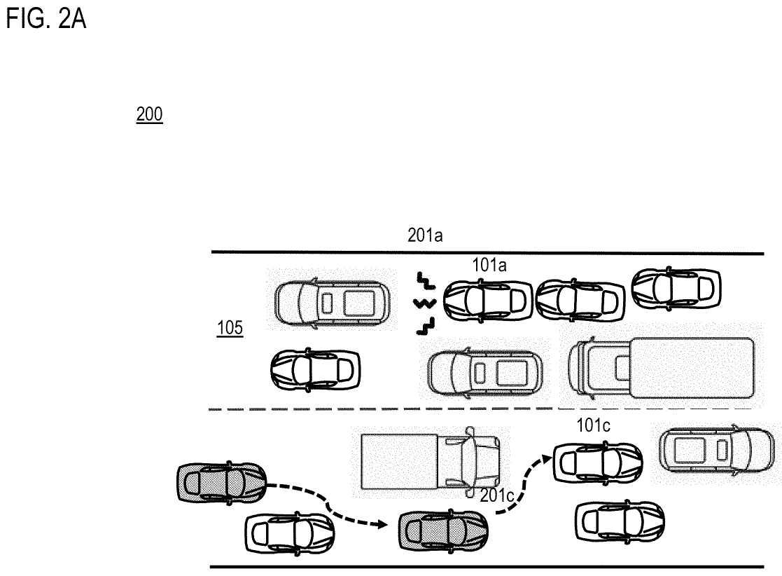

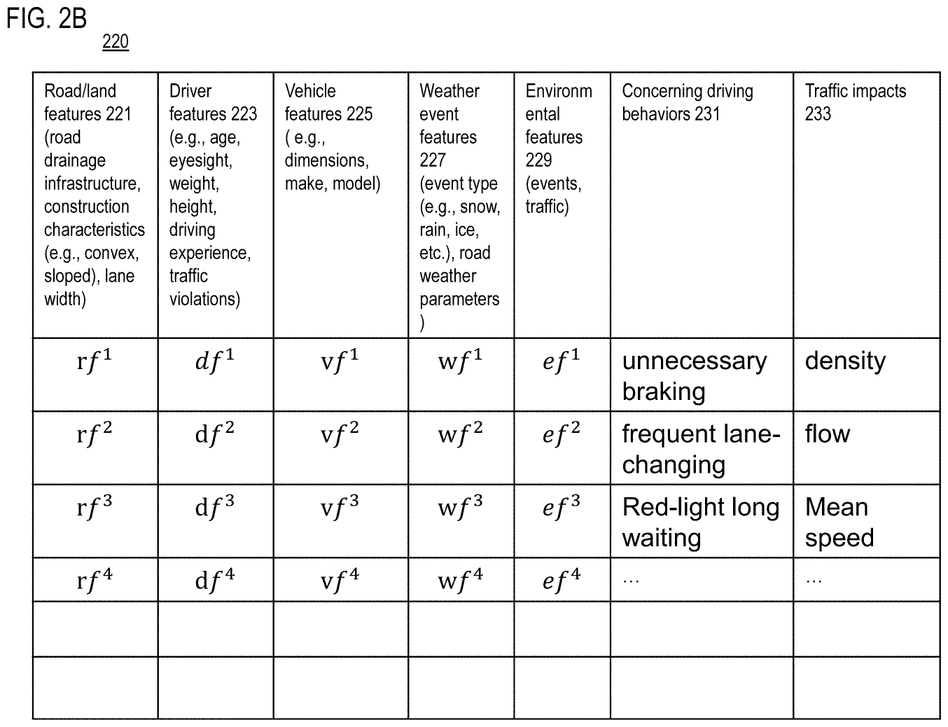

FIG. 2A is a diagram 200 illustrating example concerning driving behaviors 201, according to example embodiment(s). FIG. 2A depicts negative driving behaviors including an incident of unnecessary braking 201a by a vehicle 101a that, and incidents of frequently changing lanes 201c by a vehicle 101c.

For example, the unnecessary braking incident 201a of the vehicle 101a can cause following vehicles to brake even harder. Most drivers have relatively slow reaction times. When the vehicle 101a suddenly brakes, it will take the following drivers a second or so to hit the brakes. The slower the reaction time, the harder a driver has to brake to keep a safe distance. Same deal for the vehicles thereafter, which has to brake even harder in order to slow down much faster. Such a domino-like effect can cause the traffic slow down or even stop. In this case, the contextual parameters (e.g., a number of vehicles around, proximity, speeds, functional class of the road, and lane attributes, weather, visibility, etc.) can affect the traffic. For instance, when on a less congested road, such traffic disturbance caused by braking has less effect since the disturbance can be absorbed more easily by other drivers' reactions and appropriate adjustments. As another instance, when on a slippery road (e.g., caused by rain, running water from broken pipes, flood, oil truck spill, etc.), such disturbance caused by braking has much more effect since braking is more difficult on the slippery road.

As another example, the frequent lane changing incidents 201c of the vehicle 101c can substantially influence the surrounding vehicles and traffic flow characteristics. Weaving back and forth between lanes do not necessarily move the vehicle 101c faster, yet endangers the surrounding vehicles. The traffic speed on the target land can be deeply affected by the lane change. The speed of the target lane affected by a lane change incident is closely related to the traffic volume of the adjacent two lanes, and the system 100 can process the sensor data to determine the acceleration of lane change and the influential time. While the smaller acceleration of the lane change, the bigger variation pf the traffic speed on the target lane. In this case, the contextual parameters can affect the traffic disturbance. For instance, the interference effect of lane changing is more pronounced when heavy vehicles change lanes in comparison with passenger cars performing the same maneuver.

In one embodiment, the system 100 can leverage vehicle sensor data to assess a traffic impact index of one or more concerning driving behaviors of one user (e.g., determining the overall traffic disturbance caused by the user), and recommend the user to take action(s) in order to adjust traffic impact index (e.g., to reduce a traffic disturbance index). For instance, the system 100 can recommend driving a slower lanes where user's behavior of frequent braking can have lower impact on the traffic. As another instance, when the user is used to pull over before an exit ramp, the system 100 can recommend the user to pull over after a few meters after the exit ramp. As another instance, when the user does not take parking space(s) a little far from the destination and keeping driving around, which has a negative impact on traffic. The system 100 can recommend the user to park and walk 300 meters more. The system 100 can also make this computation and analysis retrospectively, e.g., once the user has parked and observed which parking spaces were available but not taken by the user. In short, recommendations can be made in real time or after the ride, based on what is possible and/or desired by the user.

In another embodiment, the system 100 can leverage vehicle sensor data to assess a traffic impact index of concerning driving behaviors of a group of users (e.g., all users travelling within a tile), e.g., computing an average traffic impact index for the group, and recommend the users to adjust traffic impact index (e.g., to reduce an aggregated traffic disturbance index).

In one embodiment, the system 100 can update the recommendations to one user when determining user driving behaviors (e.g., after the user accepts the recommendation(s)) and/or the contextual parameters change. In another embodiment, the system 100 can update the recommendations to the user group when determining some driving behaviors (e.g., after some of all users accept the recommendation(s)) and/or the contextual parameters change. In this case, the system 100 can incorporate the interactions of the users.

Beside unnecessary braking and frequent lane changing, the concerning driving behaviors can include driving significantly under the speed limit, double parking, waiting too long at red lights or taking too long to start at red lights (when many cars behinds), brake checking, tailgating driving, unsafe overtaking or passing, maintaining an overly large following distance from surrounding cars, taking left turns with the same estimated time of arrival (ETA) as going straight, slowly getting up to speed, letting other vehicle(s) pass when unwise and/or unnecessary, driving in a country on the opposite site, not leaving enough space for other vehicles to enter a parking space/facility or gas station, etc.

By way of example, through on-site observation based on vehicle sensors (e.g., cameras) and computer vision, the system 100 can detect and/or count the individual's concerning driving behaviors in real time. The vehicle sensors 103 may be any type of sensor. In certain embodiments, the vehicle sensors 103 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., for detecting objects proximate to the vehicle 101), an audio recorder for gathering audio data (e.g., detecting nearby humans or animals via acoustic signatures such as voices or animal noises), velocity sensors, and the like. In another embodiment, the vehicle sensors 103 may include sensors (such as LiDAR, Radar, Ultrasonic, Infrared, cameras (e.g., for visual ranging), etc. mounted along a perimeter of the vehicle 101) to detect the relative distance of the vehicle 101 from lanes or roadways, the presence of other vehicles, pedestrians, animals, traffic lights, road features (e.g., curves) and any other objects, or a combination thereof In one scenario, the vehicle sensors 103 may detect weather data, traffic information, or a combination thereof. In one example embodiment, the vehicles 101 may include GPS receivers to obtain geographic coordinates from satellites 127 for determining current location and time. Further, the location can be determined by a triangulation system such as A-GPS, Cell of Origin, or other location extrapolation technologies when cellular or network signals are available. In another example embodiment, the one or more vehicle sensors 103 may provide in-vehicle navigation services.

The observation can determine driving behavior type(s), process(es), duration(s), and/or contextual parameter data to determine traffic impacts of the concerning driving behaviors. In one embodiment, the system 100 can establish a machine learning model per driving behavior type, thereby determining that driving behavior type process, duration, and/or contextual parameters. In another embodiment, the system 100 can establish a machine learning model for identifying all driving behavior types.

In yet another embodiment, the system 100 can establish a machine learning model for determining traffic impact(s) of concerning driving behavior(s), such as calculating a traffic impact index. For instance, the system 100 can create a machine learning model for different concerning driving behaviors based on contextual parameter data (such as vehicle data, traffic data, accident reports, police reports, etc.), and analyze the correlation between the driving behaviors and traffic flows. The traffic impact index calculation can proceed as follows: establish a machine learning model for a specific concerning driving behavior (such as frequently changing lanes), set up influence rules between vehicles, then set up the traffic flow environment, and analyze the impact of parameter changes in the machine learning model on the efficiency of the traffic flow through machine learning. As mentioned, frequent lane-changing has a noticeable negative impact on traffic flow. Within a specific density range, as the frequency of lane changes increase, traffic congestion increases and traffic flow decreases.

Different from traffic impact simulators for different concerning driving behaviors, the system 100 can assess/measure actual effects of the concerning driving behaviors on traffic flow (e.g., overall traffic flow speed, density, etc.) based on the sensor data. Nevertheless, the system 100 can adapt parameters of microscopic metrics such as TH (headway), etc., and/or parameters of macroscopic metrics such as overall traffic flow speed, density, volume, number of lane changes, vehicle travel time, number of collisions, etc., to assess/measure actual effects on the traffic flow.

FIG. 2B is a diagram of an example machine learning data matrix, according to example embodiment(s). In one embodiment, the matrix/table 220 can further include input features such as road link/lane feature(s) 221 (e.g., road drainage infrastructure, construction characteristics (e.g., convex, sloped, flat, etc.), last resurfacing date, built by contractor X, pavement materials (e.g., concrete, asphalt, stone, etc.), lane width/marking/numbering/type (e.g., parking, traffic, through, auxiliary, express, reversible, dedicated, fire, loading, overtaking, slow, etc.), driver feature(s) 223 (e.g., age, eye sight, weight, height, driving experience, traffic violations, accident history, jobs, education, exercise, physical strength, health conditions, diseases, medications, etc.), vehicle feature(s) 225 (e.g., dimensions, make, model, etc.), weather event features 227 (e.g., event type (e.g., snow, rain, ice, etc.), road weather parameters (e.g., such as intensity of precipitation, pavement temperature, water film depth, etc.), environment features 229 (e.g., events, traffic, traffic light status, construction status, etc.), in order to generate output features such as concerning driving behaviors (e.g., unnecessary braking, frequent lane-changing, red-light long waiting, etc.) 231, and traffic impacts 233 (e.g., traffic density, flow/capacity, means speed of a traffic stream, etc.). For instance, traffic flow reductions can be caused by lane obstruction due to significantly under speed limit driving. In other embodiments, data features can be more specialized than what is prescribed in the matrix/table 220. In the absence of one or more sets of the features 221-229, the model can still make a prediction using the available features.

By way of example, the matrix/table 220 can list relationships among features and training data. For instance, notation [symbol] rƒ [symbol] Λi can indicate the ith set of road features, [symbol] dƒ [symbol] Λi can indicate the ith set of road lane features, [symbol] vƒ [symbol] Λi can indicate the ith set of object features, [symbol] wƒ [symbol] Λi can indicate the ith set of weather events, [symbol] eƒ [symbol] Λi can indicate the ith set of environmental features, etc.

In one embodiment, the training data can include ground truth data taken from historical driving behavior data and/or historical traffic impact data. For instance, the ground truth data can be taken via traffic images taken by satellites, unmanned aerial vehicles (UAV), traffic camera, crowd-sourced traffic reports (e.g., Waze), etc., field incident/traffic sensors, police reports, etc.

By way of example, in-pavement surface sensors can be installed in roadways to detect real-time traffic conditions (e.g., numbers of passing vehicles, speed, weights, etc.). As another example, the vehicles 101 can be equipped with sensor(s) to concerning driving behavior(s) and/or traffic conditions/impacts (e.g., traffic density, flow/capacity, means speed, etc.), environmental conditions (e.g., weather, lighting, etc.), vehicle telemetry data (e.g., speed, heading, acceleration, lateral acceleration, braking force, wheel speed, etc.), and/or other characteristics, to facilitate above-discussed embodiments. In another embodiment, the vehicles 101 can exchange such sensor data via a vehicle-to-vehicle (V2V) ad hoc communication network, a self-driving infrastructure, a cloud, etc.

For instance, in a data mining process, features of frequent lane-changing of users in a region (ground truth data) form training instances for a machine learning model for frequent lane-changing using one or more machine learning algorithms, such as random forest, decision trees, etc. For instance, the training data can be split into a training set and a test set, e.g., at a ratio of 22%:30%. After evaluating several machine learning models based on the training set and the test set, the machine learning model that produces the highest classification accuracy in training and testing can be used as the machine learning model for determining frequent lane-changing behaviors. In addition, feature selection techniques, such as chi-squared statistic, information gain, gini index, etc., can be used to determine the highest ranked features from the set based on the feature's contribution to classification effectiveness.

By analogy, a traffic impact learning model can determine traffic impact(s) based on the sensor data and/or the concerning driving behavior(s) determined by the driving behavior machine learning model(s), and the traffic impact machine learning model can be trained in a similar way. In one embodiment, the machine learning system 113 selects respective features 221-231 determine the traffic impact(s) 233 (e.g., traffic density, flow/capacity, means speed, etc.), and then determine recommended driving behavior(s).

By way of example, after detecting a user's concerning driving behaviors of waiting too long at red lights and the resulted traffic delay by the long waits, the system 100 can present the concerning driving behavior(s) and actual traffic delay(s) to the user, separately or side-by-side with driving behavior recommendation(s) and simulated improved traffic (without the traffic delay), in order to motivate the user to drive differently. For such simulation, the system 100 can use a microscopic multi-modal traffic flow simulation software (e.g., Vissim™ developed by a German company Planung Transport Verkehr AG) to change the driving behavior parameters of the vehicle in a driving simulation machine learning model to generate simulation of the recommended driving behaviors and the improved traffic (e.g., more energy/cost efficient, faster, safer, etc.). For instance, the system 100 can display the driving behavior recommendation(s) and the simulated improved traffic using augmented reality and/or virtual reality.

In one embodiment, the presentation of the behavior/impact is provided real-time or substantially real-time to the user as receiving the vehicle sensor data. In another embodiment, the presentation of the behavior/impact is provided at the end of a trip. In place of in addition to the traffic disturbing driving behaviors, the system 100 can show behaviors and maneuvers which can improve the traffic, highlight the positive behaviors that avoid some negative impact, and/or show possible recommendations for the future.

By way of example, the driving behavior recommendation(s) to replace waiting too long at red lights ca be to position the vehicle properly on a detector loop in order to register the presence of the vehicle and send a signal to a traffic control panel that the individual is waiting at the red light, and therefore the light will change. Concurrently or alternatively, the system 100 can recommend the user to peek at the pedestrian signal when going through a green light. When the pedestrian signal is “walk” or just turned to “don't walk,” the system 100 can recommend and/or simulate the individual to keep driving exactly at the speed limit will make via all subsequent lights in green. If the “don't walk” signal has been there a little while, the system 100 can recommend and/or simulate the individual to drive about a half-mile per hour over the speed limit to the next light, then continue at exactly the speed limit (i.e., no need to speed over the speed limit which will make the individual wait at a red light).

As another example, when the user brake unnecessarily or excessively, it becomes harder for drivers behind to stop without hitting the individual, especially when the road segment 105 is slippery and/or there are many vehicles behind. In this case, the system 100 can recommend and/or simulate the user to brake smoothly or to switch to a lower gear.

As another example, a user is used to brake checking that occurs when the individual intentionally hits the brakes, which often forces a following driver to also brake or take evasive action. It can happen in a road rage or an insurance fraud. Another illegal behavior is tailgating driving when driving behind another vehicle without sufficient distance to avoid collision, as necessary. In this case, the system 100 can recommend and/or simulate the individual to avoid these illegal driving behaviors.

As another example, for a user that is used aggressive overtaking, the system 100 can recommend and/or simulate avoiding driving to the left side of the center of a highway, in overtaking and passing another vehicle proceeding in the same direction.

In one embodiment, the machine learning models can learn from one or more feedback loops. For example, when a concerning driving behavior is computed/estimated to be very likely on a road lane no relevant traffic impact is detected, the concerning driving behavior machine learning model can learn from the feedback data, via analyzing and reflecting how the concerning driving behavior was determined. The concerning driving behavior machine learning model can learn the cause(s), for example, based on the vehicle model, the dimensions, etc., and include new features into the model based on this learning.

In other embodiments, the machine learning system 113 can train the machine learning models to select or assign respective weights, correlations, relationships, etc. among the features 221-233, to determine optimal action(s) to take for different concerning driving behavior(s) on different road links/lanes. In one instance, the machine learning system 113 can continuously provide and/or update the machine learning models (e.g., a support vector machine (SVM), neural network, decision tree, etc.) during training using, for instance, supervised deep convolution networks or equivalents. In other words, the machine learning system 113 trains the machine learning models using the respective weights of the features to most efficiently select optimal action(s) to take for different pavement condition difference scenarios on different road links.

In another embodiment, the machine learning system 113 of the driving platform 107 includes a neural network or other machine learning system(s) to update enhanced features on roads/lanes. In one embodiment, the neural network of the machine learning system 113 is a traditional convolutional neural network which consists of multiple layers of collections of one or more neurons (which are configured to process a portion of an input data). In one embodiment, the machine learning system 113 also has connectivity or access over the communication network 109 to the geographic database 111 that can each store sensor data, map data, weather data, the feature data, the training data, etc.

In one embodiment, the machine learning system 113 can improve the machine learning models using feedback loops based on, for example, vehicle behavior data and/or feedback data (e.g., from passengers). In one embodiment, the machine learning system 113 can improve the machine learning models using the vehicle behavior data and/or feedback data as training data. For example, the machine learning system 113 can analyze correctly identified concerning driving behavior data, traffic impact data, and/or recommended driving behavior data, missed concerning driving behavior data, traffic impact data, and/or recommended driving behavior data, etc. to determine the performance of the machine learning models.

In another example, the system 100 can incentivize drivers to take the recommend driving behavior(s) to improve traffic flow and/or driving safety, such as reducing insurance premiums, etc.

In another embodiment, the system 100 can determine an overall traffic impact (e.g., disturbance) caused by a group of drivers (e.g., within a map tile), compute an average traffic impact index for the drivers within the map tile, and/or recommend how to reduce the overall traffic impact.

In addition increasing driving awareness, the system 100 can use the driving behavior data for urban planning, routing, transportation and logistics, vehicle insurance calculation, etc. The traffic impact assessment can be made by the vehicle itself or remotely as well by some other entities/devices when relevant (e.g., a cloud), via computer vision analysis, probe analysis in conjunction with some additional data on the ground.

The above-discussed embodiments allow users (e.g., drivers, fleet operators, vehicle insurance carriers, etc.) to assess a driver behavior's impact on traffic (e.g., calculating a traffic impact index) by monitoring the driver's actions in wide context of the vehicle's surroundings via leveraging vehicle's sensors. The above-discussed embodiments be applied to improve driver awareness of their behavior impact on traffic, and provide assistance to change/improve driving behavior, thereby reducing traffic congestion and/or increasing driving safety in any roads/lanes including motorways, bicycle lanes, train tracks, airplane runways, etc. to present concerning driving behavior(s) and resulted traffic impact(s) to cause driver awareness, and/or recommend driving behavior(s) to mitigate such traffic impact(s).

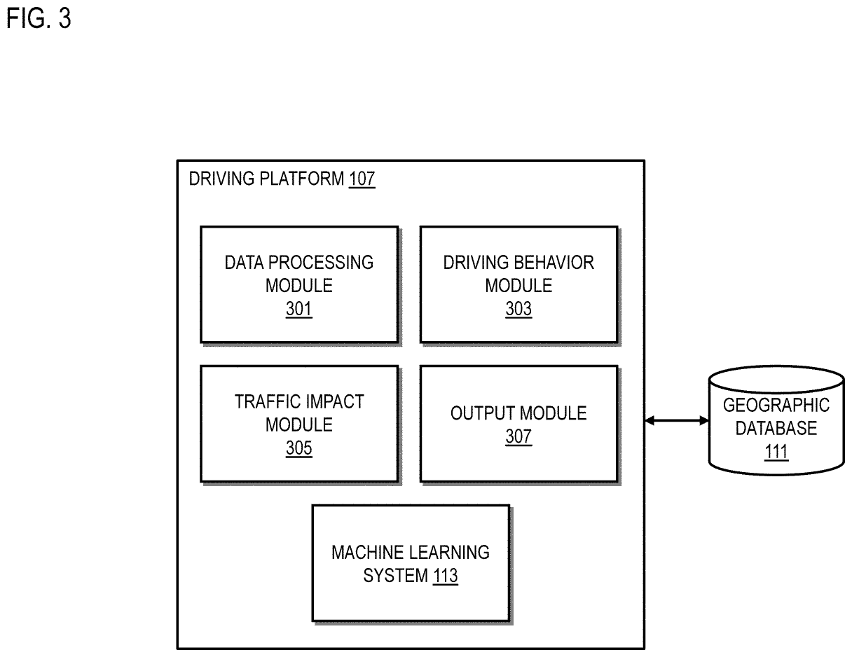

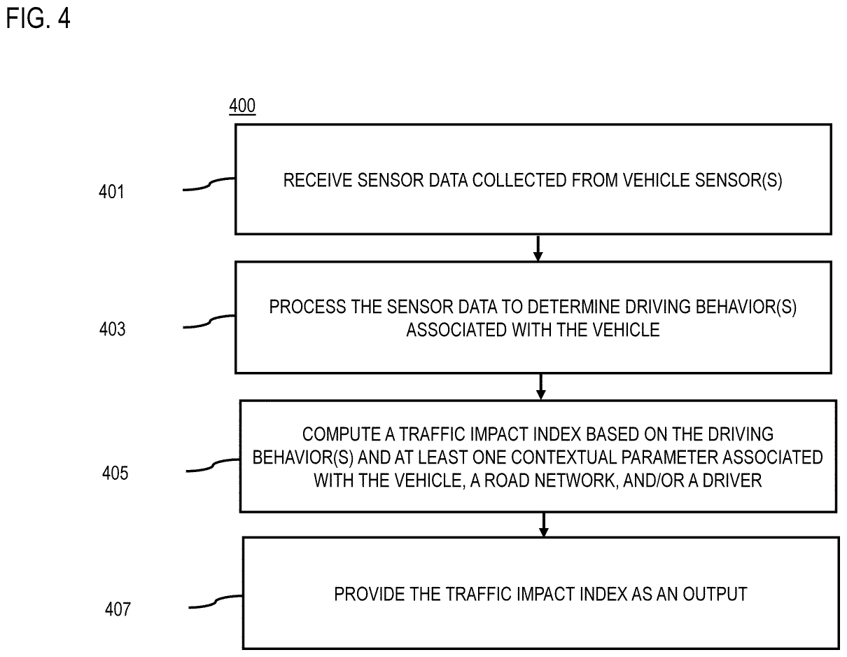

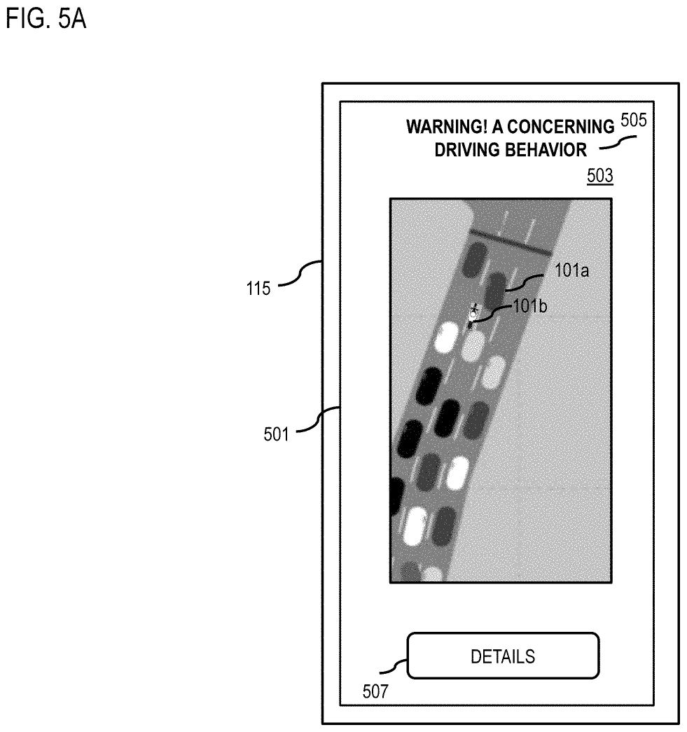

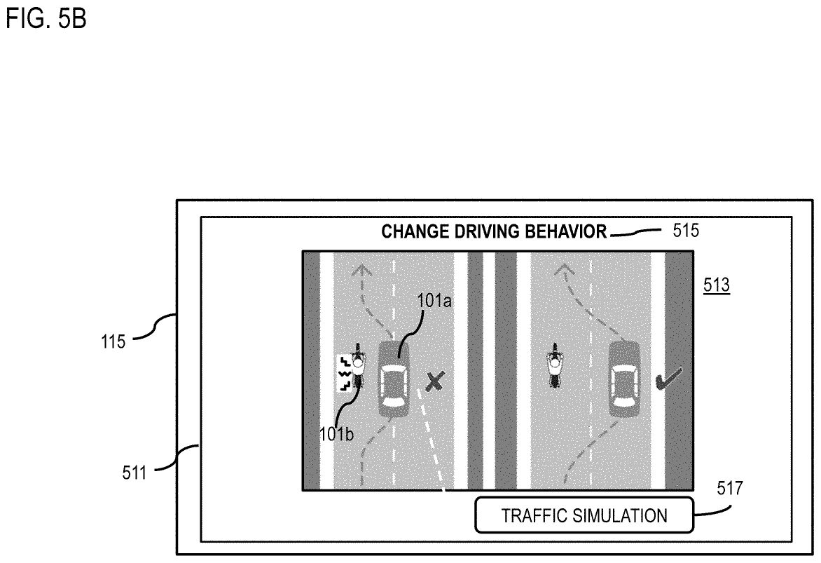

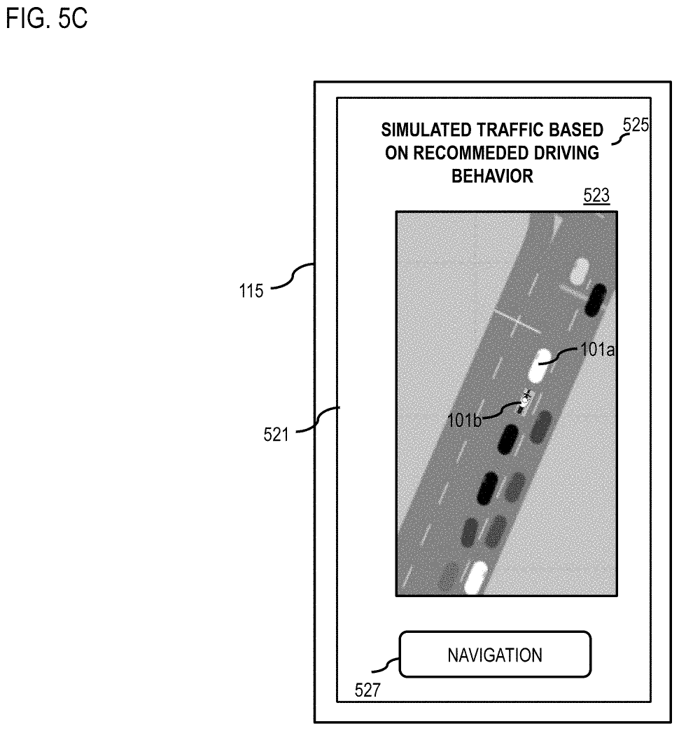

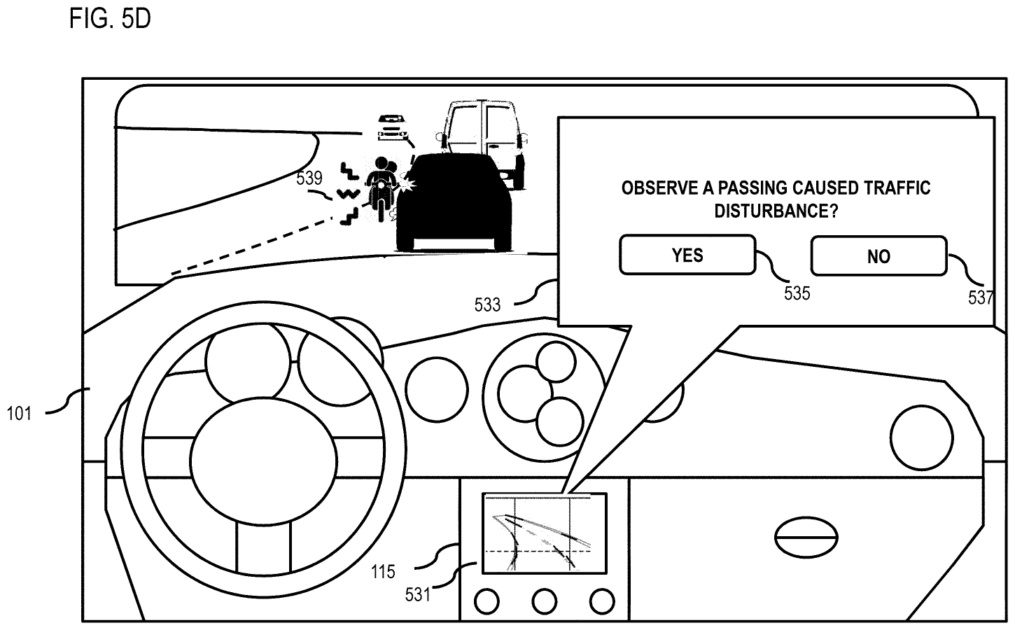

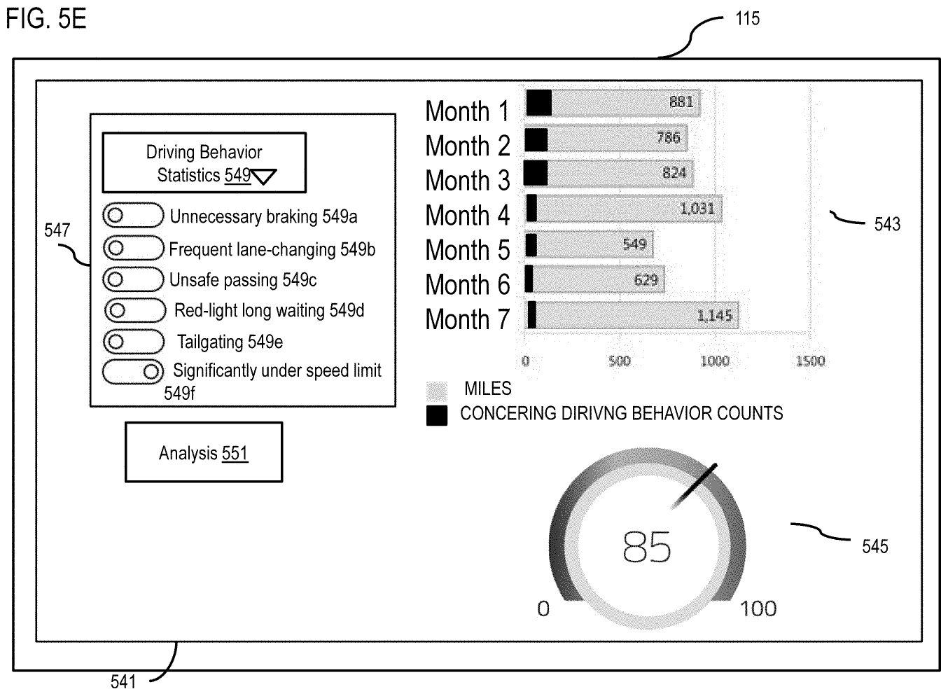

FIG. 3 is a diagram of the components of a driving platform capable of accessing traffic impact caused by individual driving behaviors, according to example embodiment(s). By way of example, the driving platform 107 includes one or more components for providing a confidence-based road event message according to the various embodiments described herein. It is contemplated that the functions of these components may be combined or performed by other components of equivalent functionality. In this embodiment, the driving platform 107 includes a data processing module 301, a driving behavior module 303, a traffic impact module 305, an output module 307, and the machine learning system 113. The above presented modules and components of the driving platform 107 can be implemented in hardware, firmware, software, or a combination thereof. Though depicted as a separate entity in FIG. 1, it is contemplated that the driving platform 107 may be implemented as a module of any of the components of the system 100 (e.g., a component of the vehicle 101, services platform 121, services 123, a client terminal, etc.). In another embodiment, one or more of the modules 301-307 and the machine learning system 113 may be implemented as a cloud-based service, local service, native application, or combination thereof. The functions of the driving platform 107, the modules 301-307, and the machine learning system 113 are discussed with respect to FIGS. 4-5 below.

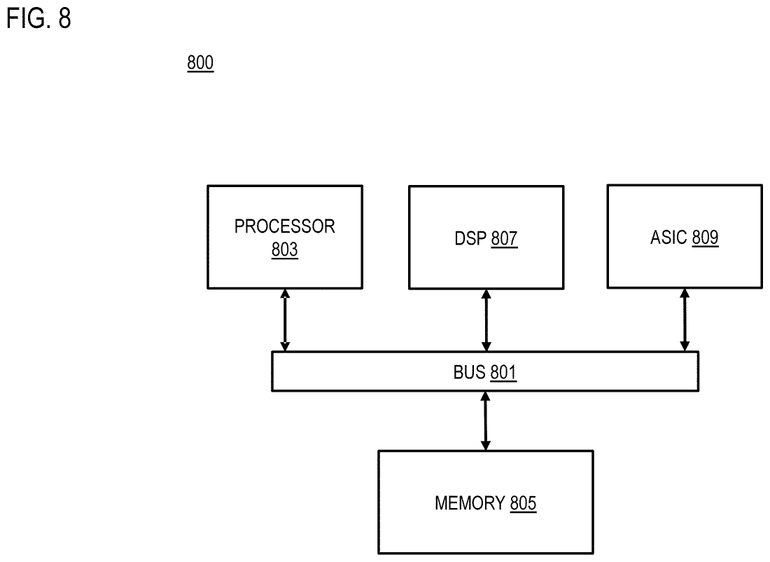

FIG. 4 is a flowchart of a process for accessing traffic impact caused by individual driving behaviors, according to example embodiment(s). In various embodiments, the driving platform 107, the machine learning system 113, and/or any of the modules 301-307 may perform one or more portions of the process 400 and may be implemented in, for instance, a chip set including a processor and a memory as shown in FIG. 8. As such, the driving platform 107, the machine learning system 113, and/or the modules 301-307 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all the illustrated steps.

In one embodiment, for example, in step 401, the data processing module 301 can receive sensor data collected from one or more sensors (e.g., sensors 103 such as camera sensors, light sensors, LiDAR sensors, radar, infrared sensors, thermal sensors, etc.) of a vehicle (e.g., a vehicle 101) traveling on a road network. For instance, the sensors can include one or more onboard vehicle sensors that detect and report in when the vehicle 101 is driven. As another instance, the data processing module 301 can receive data from one or more infrastructure sensors, such as ultrasonic sensors installed in the pavement, to determine one or more vehicle semantic events (e.g., hard braking that generates skid marks on a road surface), and the semantic events can be aggregated into one or more concerning driving behaviors. As yet another instance, the data processing module 301 can query user-specific driving behavior data recorded in third-party driving behavior databases (of a vehicle manufacturer, a car insurance carrier, etc.) for the driving behavior module 303 to process.

In one embodiment, the estimated impact of the vehicle on the traffic flow can be based on determining a deviation of the traffic flow from a reference traffic state (e.g., based on historical traffic flow data) that has been caused by the one or more driving behaviors. The impact on the traffic flow can be measured as an impact on a traffic speed, a traffic volume, a traffic congestion, a traffic density, a traffic pattern, a traffic entity (e.g., another vehicle/driver/passenger/authority/service provider), or a combination thereof.

In one embodiment, in step 403, the driving behavior module 303 can process the sensor data to determine one or more driving behaviors (e.g., the concerning driving behaviors 231 in FIG. 2B) associated with the vehicle (e.g., using the above-discussed individual or an overall concerning drinking behavior machine learning models).

In one embodiment, in step 405, the traffic impact module 305 can compute a traffic impact index (e.g., the traffic impacts 233 in FIG. 2B) based on the one or more driving behaviors and at least one contextual parameter (e.g., the features 221-229 in FIG. 2B) associated with the vehicle, the road network, a driver of the vehicle, or a combination thereof. The traffic impact index represents an estimated impact of the vehicle (e.g., vehicles 101a, 101c in FIG. 2A) on a traffic flow within at least a portion of the road network. In another embodiment, the traffic impact module 305 can generate a weighted average for the one or more driving behaviors, and compute the traffic impact index based on the weighted average.

In another embodiment, the traffic impact module 305 can provide the one or more driving behaviors, one or more features associated with the one or more driving behaviors, or a combination thereof as an input to a machine learning model to predict the estimated impact of the vehicle on the traffic flow, to compute the traffic impact index, or a combination thereof. For instance, by assigning different weights to the items within the traffic impact index (TII), the traffic impact module 305 can apply a weighted average algorithm to determine the overall traffic impact caused by a driver. As mentioned, machine learning classification can be developed where the different items in the traffic impact index become features (e.g., the features in FIG. 2B), and each feature and/or feature set can be assigned with a ground truth label (such as “high” or “low”). The traffic impact module 305 can then train the machine learning model to automatically determine a traffic impact index (TII) level as high or low depending on the feature values of the items in the traffic impact index.

In place of or in addition to the personalized per user TII calculation, the system 100 can do a tile-level analysis by computing an average TII for all users within a tile. This could be done in real time and/or in a post processing manner, and using current data and/or historical data. Depending on the TII value computed per tile, the system 100 can color the tile red or green in a map. Furthermore, depending on the TII value per tile, the system 100 can determine how much computation resource(s) to assign to that tile in a distributed processing environment.

In another embodiment, the traffic impact module 305 can compute a recommended change in the one or more driving behaviors to improve the traffic impact index, and send the recommended change to the output module 307 for presenting in a user interface. For instance, the recommended change can be presented in real time with respect to a detection of the one or more driving behaviors from the sensor data by the driving behavior module 303.

In another embodiment, the data processing module 301 can generate a navigation route for the vehicle based on the traffic impact index. For instance, the data processing module 301 can apply various positioning assisted navigation technologies, e.g., global navigation satellite systems (GNSS), WiFi, Bluetooth, Bluetooth low energy, 2/3/4/5/6G cellular signals, ultra-wideband (UWB) signals, etc., and various combinations of the technologies to derive vehicle location data and generate the navigation route.

In one embodiment, the vehicle is among a plurality of vehicles traveling within a geographic boundary (e.g., a map tile), the traffic impact index can be an overall traffic impact index computed for the geographic boundary based on respective traffic impact indexes computed for the plurality of vehicles. For instance, the traffic impact module 305 can determine the overall disturbance caused by a driver, compute an average traffic impact index for all drivers within the map tile, and/or recommend how to reduce the individual/overall traffic impact index.

In one embodiment, in step 407, the output module 307 can provide the traffic impact index as an output. In one embodiment, the output module 307 can provide the traffic impact index by providing a representation of the traffic impact index via a user interface on a device based on the output, and the user interface can depict a representation of the traffic impact index. By way of example, the user interface can be an augmented reality user interface. FIGS. 5A-5E are diagrams of example map user interfaces associated with accessing traffic impact caused by individual driving behaviors, according to example embodiment(s). For instance, the output module 307 can provider real time assessment of impact of maneuvers on traffic fluidity on an AR interface (e.g., on a windshield or glasses). As another instance, the output module 307 can provide post event visualization of the impact (in a replay fashion) on an in-vehicle infotainment (IVI) display. As another instance, the output module 307 can provide visual comparison of upcoming maneuvers (e.g., possible lane changes), ranked by their impacts on traffic fluidity (e.g., using color coding), as well as visualize the traffic impact (Positive, Neutral or Negative) of a user's maneuver on traffic fluidity. For example, if the user did action X instead, the user would cause such less impact on the traffic (e.g., traffic queue will get shorter). As another example, the output module 307 can recommend user to let a few cars pass to make traffic more fluid at an intersection, e.g., via visual and/or audio UI message(s): “please let 5 vehicles pass you here.”

In one embodiment, in FIG. 5A, the system 100 can analyze sensor data as discussed above to generate a user interface (UI) 501 (e.g., via the driving platform 107) for a UE 115 (e.g., a mobile device, a smartphone, a client terminal, etc.) that can allow a user (e.g., a driver, a mapping service provider staff, a car insurance carrier staff, a road service provider staff, a vehicle fleet operator staff, a first responder, etc.) to see an estimated or actual traffic impact image 503 currently and/or over time (e.g., 5 minutes, 15 minutes, an hour, etc.) on a road segment. The traffic impact is being or was caused by a concerning driving behavior of the user (e.g., a vehicle 101a improperly overtook a motorcycle 101b) as determined by the system 100 based on the sensor data. In this case, the system 100 presents an notification 505 of “Warning! A concerning driving behavior.” The UI 501 also presents an option of “Details” 507 in FIG. 5A for the user to see details of the concerning driving behavior.

After the option of “Details” 507 is selected, the system 100 can generate another UI 511 in FIG. 5B that shows the concerning driving behavior and a recommend driving behavior side-by-side in a graph 513. In this case, the user passed the motorcycle 101b directly from behind without a turn signal and with very narrow margin from the right side of the motorcycle 101b, thereby causing motorcycle 101b to move sideway and almost out of control, which in turn triggered the nearby vehicles braked sharply. The graph 513 also shows a recommended driving behavior: Passing the motorcycle with a turn signal and a full lane width. The system 100 presents a notification 515 of “Change driving behavior.” The UI 501 also presents an option of “Traffic Simulation” 517 in FIG. 5B for the user to see the simulated traffic of the recommended driving behavior.

After the option of “Traffic Simulation” 517 is selected, the system 100 can generate another UI 521 in FIG. 5C that shows the simulated traffic if the user takes the recommended driving behavior in a graph 523 as simulated by the system 100 based on the contextual parameters as discussed. In FIG. 5C, the system 100 presents a notification 525 of “Simulated traffic based on recommended driving behavior.” The UI 501 also presents an option of “Navigation” 527 in FIG. 5C for the user to see updated navigation directions including the recommended driving behavior.

In other instances, the UIs could also be presented via a headset, goggle, or eyeglass device used separately or in connection with a UE 115 (e.g., a mobile device). In one embodiment, the system 100 can present or surface the concerning/recommended driving behavior(s), measured/simulated traffic impact(s), map data, traffic report data, etc. in multiple interfaces simultaneously (e.g., presenting a 2D map, a 3D map, an augmented reality view, a virtual reality display, or a combination thereof). In one embodiment, the system 100 could also present the concerning/recommended driving behavior(s), measured/simulated traffic impact(s), etc. to the user through other media including but not limited to one or more sounds, haptic feedback, touch, or other sensory interfaces. For example, the system 100 could present the information through the speakers of a vehicle 101 carrying the user.

In FIG. 5D, the system 100 may provide interactive user interfaces (e.g., of UE 115 associated with the vehicle 101) for reporting concerning driving behavior(s), resulted traffic impact(s), etc. within navigation application(s) (e.g., Waze®, etc.). In this case, a UI 531 of the vehicle 101 depicts navigation information, and prompts the user with a popup 533: “Observe a passing caused traffic disturbance?” An operator and/or a passenger of the vehicle 101 can select a “yes” button 535 or a “no” button 537 based on the user's observation of a passing caused traffic disturbance 539 on a road segment.

Instead of the UI 531, the user interface can be a physical controller, a pressure sensor on a screen, or window and/or interface that enables voice commands, gestures/touch interaction, a knob, a joystick, a rollerball or trackball-based interface, or other sensors. As other examples, the user interface can be any type of sensor that can detect a user's gaze, heartrate, sweat rate or perspiration level, eye movement, body movement, or combination thereof, in order to determine a user response to confirm observations. As such, the system 100 can enable a user to confirm concerning driving behavior(s) and/or resulted traffic impact(s) as training data for the machine learning models to train as discussed.

FIG. 5E is a diagram of a user interface associated with concerning driving behaviors (CDB), according to one embodiment. In this example, a UI 541 may be generated for a UE 115 that depicts a bar chart 543 and a traffic impact scale 545. For instance, the bar chart 543 shows monthly mileages and detected CDB counts of the driver, while the traffic impact scale 545 shows a probability that the driver causes negative traffic impact(s). By analogy, the UI 541 can show CDB counts and/or a traffic impact scale of an autonomous vehicle (AV), especially during an AV driving algorithm developing stage. As another instance, some road segments can be driven by AV or level 3 to have less negative impact on traffic. In this case, the system 100 can recommend: “switch to the autonomous mode when entering the city to be more energy and traffic efficient.”

The UI 541 further shows a display setting panel 547 that includes a setting dropdown menu 549, a plurality of driving behavior statistics switches, and an input 551 of “Analysis.” By way of example, the statistics switches included Unnecessary braking 549a, Frequent lane-changing 549b, Unsafe passing 549c, Red-light long waiting 549d, tailgating 549e, Significantly under speed limit 549f, etc.

By way of example, the Significantly under speed limit 549f is switched on by a user (e.g., a driver, a passenger, a vehicle fleet management personnel, a vehicle insurance personnel, etc. with different levels of data access based on credentials), and the user further selects the input 551 of “Analysis”. The user can be a human and/or artificial intelligence. Fleet management can go beyond vehicle dispatch to include purchasing and maintaining vehicles, registering and licensing vehicles, cutting costs and maximizing profits, etc. As a result, the system 100 analyzes the monthly significantly under speed limit incidents using the above-discussed embodiments, calculates the traffic impact score as 85, and displays the score as the traffic impact scale 545. In this case, this driver may require more and/or stronger notifications (e.g., stronger-colored and/or louder notifications) of concerning driving behaviors, or more and/or stronger incentives (e.g., increasing car insurance premiums) to change the concerning driving behavior.

It is contemplated the vehicle 101 may be any type of transportation which a driver is in control of the vehicle's operation (e.g., an airplane, a drone, a train, a ferry, etc.). In another embodiment, the vehicles 101 are autonomous vehicles or highly assisted driving vehicles that can sense their environments and navigate within a travel network without driver or occupant input. In one embodiment, the vehicle sensors 103 (e.g., camera sensors, light sensors, LiDAR sensors, radar, infrared sensors, thermal sensors, and the like) acquire map data and/or sensor data during operation of the vehicle 101 within the travel network for routing, historical trajectory data collection, and/or destination prediction.

In one embodiment, one or more UEs 115 can be associated with the vehicles 101 (e.g., an embedded navigation system) a person or thing traveling within the travel network. By way of example, the UEs 115 can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, devices associated with one or more vehicles or any combination thereof, including the accessories and peripherals of these devices, or any combination thereof. It is also contemplated that the UEs 115 can support any type of interface to the user (such as “wearable” circuitry, etc.). In one embodiment, the vehicles 101 may have cellular or wireless fidelity (Wi-Fi) connection either through the inbuilt communication equipment or from the UEs 115 associated with the vehicles 101. Also, the UEs 115 may be configured to access the communication network 109 by way of any known or still developing communication protocols.

In one embodiment, the UEs 115 include a user interface element configured to receive a user input (e.g., a knob, a joystick, a rollerball or trackball-based interface, a touch screen, etc.). In one embodiment, the user interface element could also include a pressure sensor on a screen or a window (e.g., a windshield of a vehicle 101, a heads-up display, etc.), an interface element that enables gestures/touch interaction by a user, an interface element that enables voice commands by a user, or a combination thereof In one embodiment, the UEs 115 may be configured with various sensors 117 for collecting passenger sensor data and/or context data during operation of the vehicle 101 along one or more roads within the travel network. By way of example, the sensors 117 are any type of sensor that can detect a passenger's gaze, heartrate, sweat rate or perspiration level, eye movement, body movement, or combination thereof, in order to determine a passenger context or a response to output data. In one embodiment, the UEs 115 may be installed with various applications 119 to support the system 100.

In one embodiment, the driving platform 107 has connectivity over the communication network 109 to the services platform 121 that provides the services 123. By way of example, the services 123 may also be other third-party services and include mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the content providers 125 may provide content or data (e.g., including geographic data, output data, historical trajectory data, etc.). The content provided may be any type of content, such as map content, output data, audio content, video content, image content, etc. In one embodiment, the content providers 125 may also store content associated with the weather event/road link correlation data, the geographic database 111, driving platform 107, services platform 121, services 123, and/or vehicles 101. In another embodiment, the content providers 125 may manage access to a central repository of data, and offer a consistent, standard interface to data, such as a repository of weather event/road link correlation data and/or the geographic database 111.

The communication network 109 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the driving platform 107 may be a platform with multiple interconnected components. By way of example, the driving platform 107 may include multiple servers, intelligent networking devices, computing devices, components, and corresponding software for determining upcoming vehicle events for one or more locations based, at least in part, on signage information. In addition, it is noted that the driving platform 107 may be a separate entity of the system 100, a part of the services platform 121, the one or more services 123, or the content providers 125.

By way of example, the vehicles 101, the UEs 115, the driving platform 107, the services platform 121, and the content providers 125 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

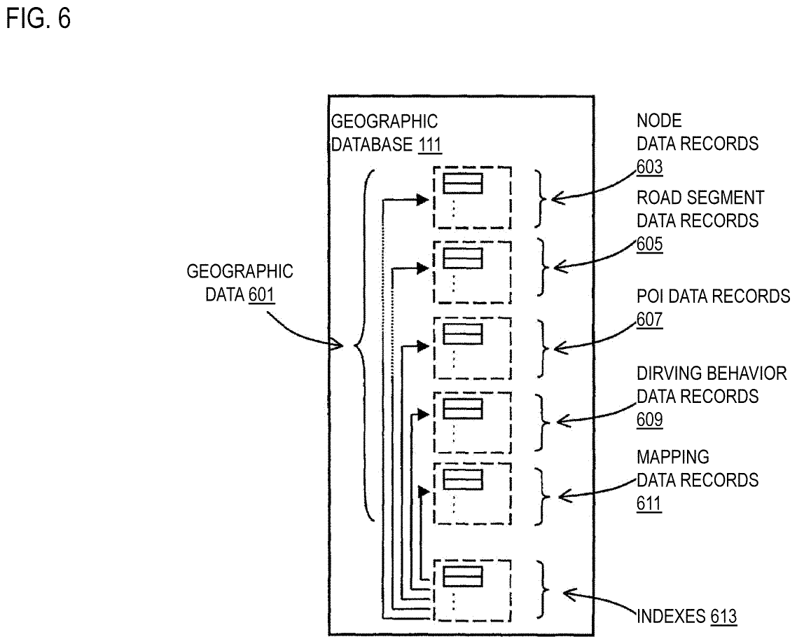

FIG. 6 is a diagram of a geographic database (such as the database 111), according to example embodiment(s). In one embodiment, the geographic database 111 includes geographic data 601 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on LiDAR or equivalent technology to collect billions of 3D points and model road surfaces and other map features down to the number lanes and their widths. In one embodiment, the mapping data (e.g., mapping data records 611) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 603, road segment or link data records 605, POI data records 607, driving behavior data records 609, mapping data records 611, and indexes 613, for example. More, fewer or different data records can be provided. In one embodiment, additional data records (not shown) can include cartographic (“carto”) data records, routing data, and maneuver data. In one embodiment, the indexes 613 may improve the speed of data retrieval operations in the geographic database 111. In one embodiment, the indexes 613 may be used to quickly locate data without having to search every row in the geographic database 111 every time it is accessed. For example, in one embodiment, the indexes 613 can be a spatial index of the polygon points associated with stored feature polygons.

In exemplary embodiments, the road segment data records 605 are links or segments representing roads, streets, or paths, as can be used in the calculated route or recorded route information for determination of one or more personalized routes. The node data records 603 are end points (such as intersections) corresponding to the respective links or segments of the road segment data records 605. The road link data records 605 and the node data records 603 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 607. The geographic database 111 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city). In one embodiment, certain attributes, such as lane marking data records, mapping data records and/or other attributes can be features or layers associated with the link-node structure of the database.

In one embodiment, the geographic database 111 can also include driving behavior data records 609 for storing concerning driving behavior data, estimated traffic impact data, recommended driving behavior data, simulated traffic impact data, training data, prediction models, annotated observations, computed featured distributions, sampling probabilities, and/or any other data generated or used by the system 100 according to the various embodiments described herein. By way of example, the driving behavior data records 609 can be associated with one or more of the node records 603, road segment records 605, and/or POI data records 607 to support localization or visual odometry based on the features stored therein and the corresponding estimated quality of the features. In this way, the records 609 can also be associated with or used to classify the characteristics or metadata of the corresponding records 603, 605, and/or 607.

In one embodiment, as discussed above, the mapping data records 611 model road surfaces and other map features to centimeter-level or better accuracy. The mapping data records 611 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 611 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 611 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 611.

In one embodiment, the mapping data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 125 in association with the services platform 121 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicles 101 and/or UEs 115) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a user terminal 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for accessing traffic impact caused by individual driving behaviors may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

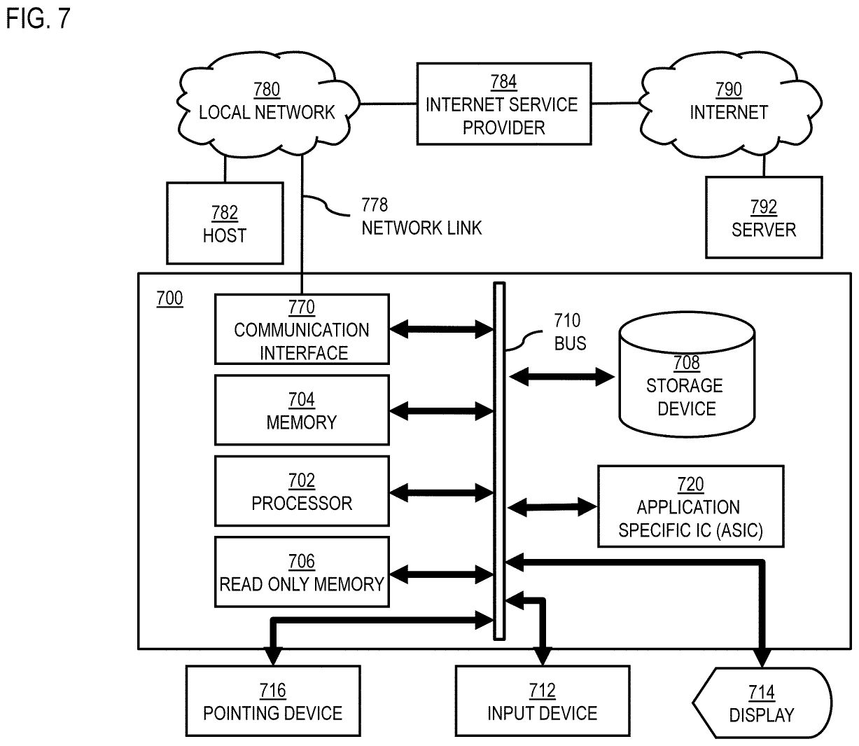

FIG. 7 illustrates a computer system 700 upon which an embodiment of the invention may be implemented. Computer system 700 is programmed (e.g., via computer program code or instructions) to access traffic impact caused by individual driving behaviors as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to accessing traffic impact caused by individual driving behaviors. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for accessing traffic impact caused by individual driving behaviors. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for accessing traffic impact caused by individual driving behaviors, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 109 for accessing traffic impact caused by individual driving behaviors.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

FIG. 8 illustrates a chip set 800 upon which an embodiment of the invention may be implemented. Chip set 800 is programmed to access traffic impact caused by individual driving behaviors as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to access traffic impact caused by individual driving behaviors. The memory 805 also stores the data associated with or generated by the execution of the inventive steps.

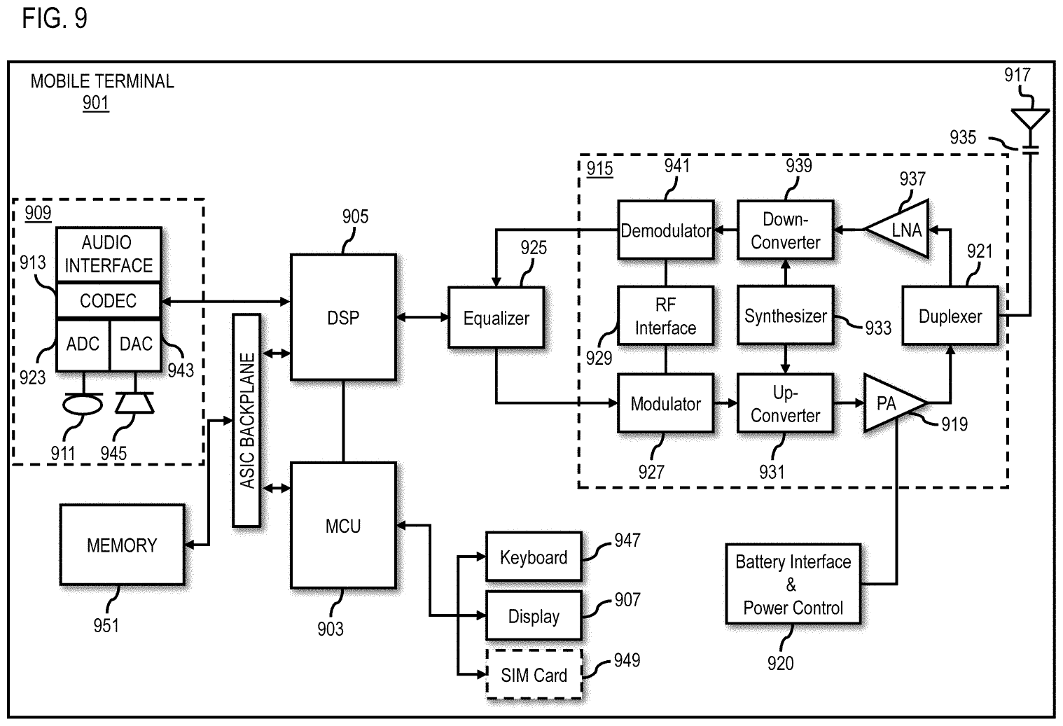

FIG. 9 is a diagram of exemplary components of a mobile terminal 901 (e.g., handset or vehicle or part thereof) capable of operating in the system of FIG. 1, according to example embodiment(s). Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to access traffic impact caused by individual driving behaviors. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving, by one or more processors, sensor data collected from one or more sensors of a vehicle traveling on a road network;
processing, by the one or more processors, the sensor data to determine one or more driving behaviors associated with the vehicle;
computing, by the one or more processors, a traffic impact index based on the one or more driving behaviors and at least one contextual parameter associated with the vehicle, the road network, a driver of the vehicle, or a combination thereof, wherein the traffic impact index represents an estimated impact of the vehicle on a traffic flow within at least a portion of the road network; and
providing, by the one or more processors, the traffic impact index as an output.

2. The method of claim 1, wherein the estimated impact of the vehicle on the traffic flow is based on determining a deviation of the traffic flow from a reference traffic state that has been caused by the one or more driving behaviors.

3. The method of claim 1, wherein the impact on the traffic flow is measured as an impact on a traffic speed, a traffic volume, a traffic congestion, a traffic density, a traffic pattern, a traffic entity, or a combination thereof.

4. The method of claim 1, wherein providing the traffic impact index comprises providing a representation of the traffic impact index via a user interface on a device based on the output,
wherein the user interface depicts a representation of the traffic impact index.

5. The method of claim 4, wherein the user interface is an augmented reality user interface.

6. The method of claim 1, further comprising:
generating a weighted average for the one or more driving behaviors,
wherein the traffic impact index is computed based on the weighted average.

7. The method of claim 1, further comprising:
providing the one or more driving behaviors, one or more features associated with the one or more driving behaviors, or a combination thereof as an input to a machine learning model to predict the estimated impact of the vehicle on the traffic flow, to compute the traffic impact index, or a combination thereof.

8. The method of claim 1, wherein the vehicle is among a plurality of vehicles traveling within a geographic boundary, and wherein the traffic impact index is an overall traffic impact index computed for the geographic boundary based on respective traffic impact indexes computed for the plurality of vehicles.

9. The method of claim 8, wherein the geographic boundary sets a map tile.

10. The method of claim 1, further comprising:
computing a recommended change in the one or more driving behaviors to improve the traffic impact index; and
presenting the recommended change in a user interface.

11. The method claim 10, wherein the recommended change is presented in real time with respect to a detection of the one or more driving behaviors from the sensor data.

12. The method of claim 1, further comprising:
generating a navigation route for the vehicle based on the traffic impact index.

13. An apparatus comprising:
at least one processor; and
at least one memory including computer program code for one or more programs,
the at least one memory and the computer program code configured to, with the at least one processor, cause the apparatus to perform at least the following,
receive sensor data collected from one or more sensors of a vehicle traveling on a road network;
process the sensor data to determine one or more driving behaviors associated with the vehicle;
compute a traffic impact index based on the one or more driving behaviors and at least one contextual parameter associated with the vehicle, the road network, a driver of the vehicle, or a combination thereof, wherein the traffic impact index represents an estimated impact of the vehicle on a traffic flow within at least a portion of the road network; and
provide the traffic impact index as an output.

14. The apparatus of claim 13, wherein the estimated impact of the vehicle on the traffic flow is based on determining a deviation of the traffic flow from a reference traffic state that has been caused by the one or more driving behaviors.

15. The apparatus of claim 13, wherein the impact on the traffic flow is measured as an impact on a traffic speed, a traffic volume, a traffic congestion, a traffic density, a traffic pattern, a traffic entity, or a combination thereof

16. The apparatus of claim 13, wherein the apparatus provides the traffic impact index by providing a representation of the traffic impact index via user interface on a device based on the output,
wherein the user interface depicts a representation of the traffic impact index.

17. The apparatus of claim 13, wherein the apparatus is further caused to:
compute a recommended change in the one or more driving behaviors to improve the traffic impact index; and
present the recommended change in a user interface.

18. A non-transitory computer-readable storage medium carrying one or more sequences of one or more instructions which, when executed by one or more processors, cause an apparatus to perform:
receiving sensor data collected from one or more sensors of a vehicle traveling on a road network;
processing the sensor data to determine one or more driving behaviors associated with the vehicle;
computing a traffic impact index based on the one or more driving behaviors and at least one contextual parameter associated with the vehicle, the road network, a driver of the vehicle, or a combination thereof, where the traffic impact index represents an estimated impact of the vehicle on a traffic flow within at least a portion of the road network; and
providing the traffic impact index as an output.

19. The non-transitory computer-readable storage medium of claim 18, wherein the estimated impact of the vehicle on the traffic flow is based on determining a deviation of the traffic flow from a reference traffic state that has been caused by the one or more driving behaviors.

20. The non-transitory computer-readable storage medium of claim 18, wherein the impact on the traffic flow is measured as an impact on a traffic speed, a traffic volume, a traffic congestion, a traffic density, a traffic pattern, a traffic entity, or a combination thereof.
